(19) United States
(12) Patent Application Publication
(10) Pub. No.: US 2026/0347547 A1
(43) Pub. Date: Nov. 5, 2026

(54) SECONDARY AMINE TERMINATED BLOCK POLYAMIDE AND PREPARATION METHOD AND USE THEREOF

(71) Applicant: EVONIK OPERATIONS GMBH, Essen (DE)

(72) Inventors: Yufan Wu, Shanghai (CN); Qiubai Peng, Shanghai (CN); Limin Zhou, Shanghai (CN)

(73) Assignee: EVONIK OPERATIONS GMBH, Essen (DE)

(21) Appl. No.: 19/486,680

(22) PCT Filed: May 25, 2023
(86) PCT No.: PCT/CN2023/096316

§ 371 Date: Nov. 21, 2025

(51) Int. Cl. C08G 81/00

(52) U.S. Cl. CPC C08G 81/00; C08G 2150/00; C08G 2170/00

(57) ABSTRACT

The present invention discloses a secondary amine terminated block polyamide and preparation method and use thereof, in particular a block polyamide comprising terminal secondary amine groups, an epoxy curing composition comprising said block polyamide, an epoxy formulation comprising said epoxy curing composition or said block polyamide as epoxy curing agent, a cured product of said epoxy formulation, an article comprising said cured product, a process for preparing said block polyamide and use of said block polyamide as epoxy curing agents in coatings, adhesives, fiber reinforced composites, and mortars.

### TECHNICAL FIELD

The invention relates to a block polyamide comprising terminal amine groups, an epoxy curing composition comprising said block polyamide, a process for preparing said block polyamide and use of said block polyamide as epoxy curing agents in coatings, adhesives, composites, and mortars.

### BACKGROUND ART

Epoxies are one of the most versatile classes of polymers with diverse applications such as coatings, adhesives, composites and so on. Most cured epoxy resins provide amorphous thermosets with excellent mechanical strength and toughness; outstanding chemical, moisture, and corrosion resistance; no volatiles emission and low shrinkage upon cure.

However, some cross-linked, unmodified epoxy systems exhibit brittleness, poor flexibility, and low impact strength and fracture resistance. In general, there are two approaches used to modify epoxies to improve these features.

One approach is to use toughening agent in the epoxy system. Elastomers such as carboxyl-terminated poly(butadiene-co-acrylonitrile)s (CTBN) and amine-terminated poly(butadiene-co-acrylonitrile)s (ATBN) have been popular tougheners for epoxies. But these elastomers suffer from high cost.

Another approach is to use flexible curing agent for epoxy system. Polyamide hardeners, based on dimer fatty acids and polyamines, enhance the flexibility or elongation by providing chain segments with greater free rotation between cross-links. Polyoxyalkylene polyamines, such as JEFFAMINE® D230, JEFFAMINE® D400 (commercial names of Huntsman), are also common flexible curing agent either used solely or modified into polyamides. However, Jeffamines sometimes suffer from compatibility problem when mixing with epoxy resin and flexibility of these curing agents still need further improvement.

U.S. Pat. No. 5,128,441 discloses block polyamidopolyamine prepared by reacting a polyoxyalkylene diamine or triamine containing terminal primary amine groups with an amount of an aliphatic or an aromatic dicarboxylic acid or an anhydride or an alkyl ester thereof sufficient to react one mole of the dicarboxylic acid reactant with each terminal primary amine group of the polyoxyalkylene polyamine to provide an intermediate condensation product containing terminal carboxyl groups, and reacting one mole of an organic di-primary amine with each terminal carboxyl group of the intermediate reaction product to provide the primary amine-terminated polyamido block condensation products.

According to U.S. Pat. No. 5,128,441, it is essential, that terminal primary amine groups are present in the block polyamido diamine and triamine condensation products. Such block polyamido diamine and triamine condensation products increase in stiffness or hardness, however there is still room for improvement with respect to flexibility.

U.S. Pat. No. 4,082,708A discloses a two-part epoxy adhesive composition in which part A comprises a curable liquid epoxide and part B comprises a bisamino piperazine containing thermoplastic polyamide hardener. U.S. Pat. No. 4,082,708A teaches that secondary amines can be utilized in making polyamides of this invention, although termination of the polyamide with secondary amino substituents is preferably avoided; that is, it is preferred that the secondary amines be “buried” in the polyamide structure.

US2003173707 discloses the use of hot melt adhesives for the production of moldings and a process for the production of such moldings. Said hot melt adhesive is polyamide that is produced from [a] 80 to 100 mol % of one or more C4-C18 dicarboxylic acid(s) [b] 10 to 100 mol % of at least one aliphatic diamine [c] 10 to 80 mol % of one or more cycloaliphatic diamines [d] 0 to 80 mol % of polyether diamines. The polyamide produced by one step process is a hot melt adhesive, which is very different from curing agents for epoxy system.

Therefore, there is a need for polyamides used as epoxy curing agents with an effective combination of cost-effectiveness and high flexibility.

### SUMMARY OF THE INVENTION

The aim of the present invention is to provide novel amine terminated block polyamide for curing agents for epoxy system to be cost-effective and highly flexible.

The inventors have thus discovered that the block polyamide of formula (I) according to the invention make it possible to solve this (these) technical problem(s).

The block polyamide of the present invention is a secondary amine terminated block polyamide of formula (I) below:

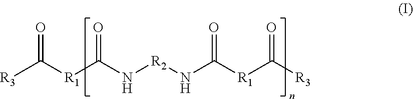

in which formula (I):
R₁ each independently represents a divalent aliphatic or aromatic group having an average molecular weight of 42 to about 700, particularly 200 to 700, more particularly 500 to 600 and containing from 3 to 42 carbon atoms, particularly 10 to 42 carbon atoms, more particularly 30 to 40 carbon atoms;
R₂ represents:

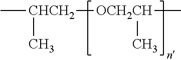

wherein n′ represents a positive number having an average value of from 2 to 80, particularly from 2 to 20, and more particularly from 2 to 10,
or

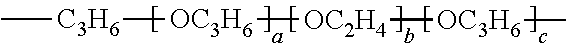

wherein —C3H₆— may be linear or branched, a+c equals a positive number having an average value of 2 to about 10 and b is a positive number having an average value of from 1 to about 50, or

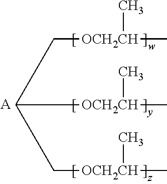

wherein A represents a trivalent hydrocarbon group consisting of 3 to 6 carbon atoms, resulting from the propoxylation of a susceptible trihydric alcohol containing from 3 to 6 carbon atoms, and
w, y and z are positive integers and the average value of the sum of w+y+z is from 4 to about 120;
n represents an integer from 1 to 10;
R₃ each independently represents a monovalent group having the formula:

R₄NH—R₅—NR₆—,
wherein R₄ and R₅ each independently represents an aliphatic, alicyclic, or aromatic group containing 1 to 10 carbon atoms,
R₆ represents a hydrogen atom or an aliphatic, alicyclic, or aromatic group containing 1 to 10 carbon atoms; or
R₃ each independently represents a monovalent group having the formula:

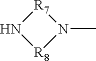

R₇ and R₈ form, together with the two nitrogen atoms to which R₇ and R₈ are attached, an optionally alkyl groups substituted 4 to 7-membered heterocycle; or
R₃ each independently represents a monovalent group having the formula:

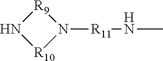

R₉ and R₁₀ form, together with the two nitrogen atoms to which R₉ and R₁₀ are attached, an optionally alkyl groups substituted 4 to 7-membered heterocycle,
R₁₁ represents a divalent aliphatic saturated or unsaturated hydrocarbon group containing from 1 to 10 carbon atoms, particularly 1 to 5 carbon atoms, and more particularly 2 to 3 carbon atoms,
wherein said block polyamide has an average molecular weight ranging from about 800 to about 8000.

Herein, the molecular weight is number-averaged and is tested by Gel Permeation Chromatography (GPC).

The amine terminated block polyamide of formula (I) is characterized by the presence of terminal secondary amine groups. Compared to the primary amine terminated polyamide, the lower functionality of the secondary amine terminated polyamide leads to lower crosslinking density and higher flexibility when cured with epoxy resin.

The inventive block polyamide is cost effective but can achieve good strength and flexibility. Therefore, it can be used to replace ATBN in at least some applications.

The invention also provides an epoxy curing composition at least comprising any one block polyamide of formula (I) as defined previously, a process for preparing the block polyamides of the invention, and use of the block polyamides of the invention as epoxy curing agents in coatings, adhesives, fiber reinforced composites, and mortars.

When said block polyamide used in epoxy system, the cured product exhibits properties of fast-cure and high flexibility, which are attractive properties in many applications, for instance, coatings, adhesives, fiber reinforced composites, and mortars, etc.

Other advantages of the present invention would be apparent for a person skilled in the art upon reading the specification.

### DETAILED DESCRIPTION OF THE INVENTION

A subject of the invention is thus a secondary amine terminated block polyamide of formula (I) below.

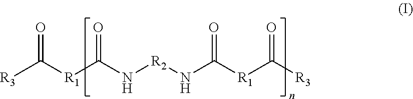

According to one particular embodiment of the invention, the block polyamides of formula (I) are such that R₁ each independently represents a divalent aliphatic saturated or unsaturated hydrocarbon group containing from 3 to 42 carbon atoms, particularly 10 to 42 carbon atoms, more particularly 30 to 40 carbon atoms and having an average molecular weight of 42 to about 700, particularly 200 to 700, more particularly 500 to 600.

Suitable COOH—R₁—COOH) that may be used as starting materials for the present invention can be selected from for example, adipic acid wherein R₁ represents a divalent butyl, dodecanedioic acid wherein R₁ represents a divalent decyl, glutaric acid wherein R₁ represents a divalent propyl, azelaic acid wherein R₁ represents a divalent heptyl, sebacic acid wherein R₁ represents a divalent octyl, or the dimer acids from dimerization of tall oil fatty acids.

According to one particular embodiment of the invention, the block polyamides (I) are such that R₂ represents

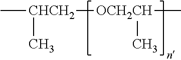

with n′ representing a positive number having an average value of from 2 to 80, particularly from 2 to 20, and more particularly from 2 to 10.

Representative NH₂R₂NH₂ that may be used as starting materials for the present invention includes JEFFAMINE® D-230 amine wherein the value of n′ is 2.6, JEFFAMINE® D-400 amine wherein n′ has a value of 5.6, JEFFAMINE® D-2000 amine wherein n′ has a value of about 33.

According to another particular embodiment of the invention, the block polyamides of formula (I) are such that R₂ represents

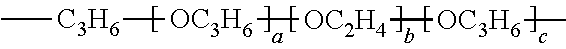

wherein —C3H₆— may be linear or branched, a+c equals a positive number having an average value of 2 to about 10 and b is a positive number having an average value of from 1 to about 50.

Representative NH₂R₂NH₂ that may be used as starting materials for the present invention includes JEFFAMINE® ED-600 where b is about 8.5 and the value of a+c is about 2.5, JEFFAMINE® ED-900 where the value of a+c is about 2.5 and the value of b is about 15.5, JEFFAMINE® ED-2001 wherein a+c has a value of about 2.5 and the value of b is about 40, Ancamine® 1922A wherein a has a value of 0, c has a value of 1 and the value of b is 2.

According to one embodiment of the invention, the block polyamides are of formula (I) in which R₂ represents

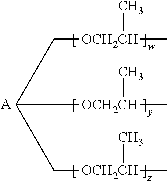

wherein A represents a trivalent hydrocarbon group consisting of 3 to 6 carbon atoms, resulting from the propoxylation of a susceptible trihydric alcohol containing from 3 to 6 carbon atoms, and
w, y and z are positive integers and the average value of the sum of w+y+z is from 4 to about 120.

Examples of triamines R₂(NH₂)₃ that may be used as starting materials for the present invention include JEFFAMINE® T-403 wherein A represents a trimethylol propane nucleus, and the average value of the sum of w+y+z is about 5.3, JEFFAMINE® T-3000 wherein A represents a trimethylol propane nucleus, and the average value of the sum of w+y+z is about 50, and JEFFAMINE® T-5000 wherein A represents a glycerol nucleus and the average value of the sum of w+y+z is about 86.

According to one embodiment of the invention, the block polyamides (I) are such that R₆ represents a hydrogen atom.

According to one particular embodiment of the invention, the block polyamides (I) are such that R₃ each independently represents a monovalent group having the formula:

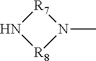

wherein R₇ and R₈ form, together with the two nitrogen atoms to which R₇ and R₈ are attached, a piperazinium ring, the piperazinium ring being optionally alkyl groups substituted.

According to one particular embodiment of the invention, the block polyamides (I) are such that R₃ each independently represents a monovalent group having the formula:

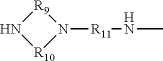

wherein R₉ and R₁₀ form, together with the two nitrogen atoms to which Ry and R₁₀ are attached, a piperazinium ring, the piperazinium ring being optionally alkyl groups substituted,
R₁₁ is as defined previously.

More particularly, the diamine R₃H that may be used as starting materials for the present invention represents diamines chosen from N-(2-aminoethyl)piperazine, piperazine and 3-(cyclohexylamino)-1-propylamine. In one embodiment, R₃ is derived from diamines from selected the group consisting of N-(2-aminoethyl)piperazine, piperazine, and 3-(cyclohexylamino)-1-propylamine.

The secondary amine terminated block polyamide of the invention may be used as epoxy curing agents in applications such as coatings, adhesives, fiber reinforced composites, and mortars.

In some embodiments, the diamine R₃H is N-(2-aminoethyl)piperazine. In some embodiments, the secondary amine terminated block polyamide of the invention is used as epoxy curing agent in coatings.

The invention further provides a process for preparing the secondary amine terminated block polyamide of formula (I), which comprises
(1) reacting a polyoxyalkylene polyamine NH₂R₂NH₂ or R₂ (NH₂)₃ with a dicarboxylic acid having the formula COOH—R₁—COOH) or an anhydride or a C1-C4 alkyl ester thereof to provide a carboxyl terminated prepolymer, and
(2) reacting the carboxyl terminated prepolymer with a diamine R₃H to give the secondary amine terminated block polyamide,
wherein R₁, R₂, R₃ are as defined previously.

Preferably, the molar ratio of the polyoxyalkylene polyamine to the dicarboxylic acid or an anhydride or a C1-C4 alkyl ester thereof is 1:1.05 to 1:4; the molar ratio of the diamine R₃H to the difference between the dicarboxylic acid or an anhydride or a C1-C4 alkyl ester thereof and the polyoxyalkylene polyamine is 1:1.05 to 1:4 such that one mole of diamine reacts with each of the terminal carboxyl groups of the prepolymer from the step (1), to thereby form an amine-terminated block polyamide.

The condensation reactions of step (1) and step (2) are preferably heated to 50-280° C., preferably 150-280° C., more preferably 180-250° C. optionally in vacuum for 2-6 hours. Preferably, any water generated from the reactions is removed.

A subject of the present invention is also an epoxy curing composition comprising the block polyamide of formula (I) as defined previously. The epoxy curing composition may be used as epoxy curing agents in applications such as coatings, adhesives, fiber reinforced composites, and mortars.

According to one particular embodiment of the invention, the block polyamide of formula (I) as defined previously represent from 1 to 100 wt %, more particularly from 10 to 90 wt %, preferentially from 20 to 70 wt %, relative to the total weight of the epoxy curing composition.

The epoxy curing composition that is useful in the context of the invention may optionally comprise at least one additional polyamine conventionally used as curing agent. It may be chosen from Ancamide® 350A or Ancamine® 1618, commercially available from Evonik Industries AG.

When they are present, the content of additional polyamide in the epoxy curing composition generally ranges from 10 to 90 wt % and preferably from 20 to 50 wt % relative to the weight of the epoxy curing composition.

A subject of the present invention is also an epoxy formulation, selected from coatings, adhesive, mortars, fiber reinforced composites, which comprises the epoxy curing composition of the invention, or the block polyamide of the invention as epoxy curing agent, and an epoxy resin. The epoxy resin is already known in the art.

In the present disclosure, the epoxy resin can preferably include one or more glycidyl ethers selected from the group of glycidyl ethers of: resorcinol, hydroquinone, 4,4′-methylenebis(2,6-dimethylphenol) (tetramethyl bisphenol F), bis-(4-hydroxy-3,5-difluorophenyl)-methane, 1,1-bis-(4-hydroxyphenyl)-ethane, 2,2-bis-(4-hydroxy-3-methylphenyl)-propane, 2,2-bis-(4-hydroxy-3,5-dichlorophenyl) propane, 2,2-bis-(4-hydroxyphenyl)-propane (bisphenol A), bis-(4-hydroxyphenyl)-methane (bisphenol F), and any combination thereof. The epoxy resins are commercially available from various chemical manufacturers, for example, D.E.R.™ 331, 351, or 731 from Olin Corporation. Several epoxy compounds are also described, for example, in EP 675 185 A1.

To bring in more functionality or features to satisfy industrial requirements, the epoxy formulation can preferably include additives. Preferred additives can be selected from the group consisting of fillers, reinforcing agents, coupling agents, toughening agents, defoamers, dispersants, lubricants, colorants, marking materials, dyes, pigments, IR absorbers, antistats, anti-blocking agents, nucleating agents, crystallization accelerators, crystallization delayers, conductivity additives, carbon black, graphite, carbon nanotubes, graphene, desiccants, de-molding agents, levelling auxiliaries, flame retardants, separating agents, optical lighteners, rheology additives, photochromic additives, softeners, adhesion promoters, anti-dripping agents, metallic pigments, stabilizers, metal glitters, metal coated particles, porosity inducers, plasticizers, glass fibers, nanoparticles, flow assistants, and combinations thereof.

A subject of the present invention is also a cured product of epoxy formulation as described above. The curing method is well known in the art.

A subject of the present invention is also an article comprising the above mentioned cured product and a substrate such as metal, plastic, ceramic, concrete.

A subject of the present invention is also the use of the block polyamides of formula (I) as defined previously, as epoxy curing agents in coatings, adhesives, fiber reinforced composites, and mortars.

The invention is now described in detail by the following examples. The scope of the invention should not be limited to the embodiments of the examples.

### EXAMPLES

TABLE 1
raw materials

| Raw material | Remark | Source |
|---|---|---|
| D.E.R. 331 | Bisphenol A epoxy resin(EEW = 190) | Olin Corporation |
| N-AEP | N-aminoethyl piperazine | Huntsman |
| Dimer acid | Dimerization product | Jiangsu Yonglin |
| | of tall oil fatty acid | Chemical Oil Co., |
| | | Ltd., China |
| JEFFAMINE | Polypropylene diamine, | Huntsman |
| D400 | MW = 430 g/mol | |
| JEFFAMINE | Polypropylene diamine, | Huntsman |
| D2000 | MW = 2000 g/mol | |
| TETA | Triethylene tetramine | Olin Corporation |
| IPDA | Isophorone diamine | Evonik |
| Piperazine | piperazine | Aldrich |
| Ancamine ® | 3,3′-(Oxybis(2,1-ethane- | Evonik |
| 1922A | diyloxy))bis-1-propanamine | |
| Epodil ® 742 | Mono functional reactive | Evonik |
| | epoxy diluent | |
| Ancamide ® | Polyamide curing agent | Evonik |
| 350A | | |
| Ancamine ® | polyamine adduct curing agent | Evonik |
| 1618 | | |
| Hypro ® | amine terminated butadiene- | Huntsman |
| 1300 [symbol] | acrylonitrile copolymer | |
| 16 ATBN | | |

TABLE 2
test methods

| Test items | Remark | Test standard |
|---|---|---|
| Viscosity | Brookfield Viscometer | ASTM D445-83 |
| | LVDV-II + Pro | |
| Amine value | Mettler Toledo DL50 | ASTM D2074 |
| Drying time | BK drying recorder | ASTM D5895 |
| | II phase: tack-free. | |
| | III phase: dry-hard. | |
| Hardness | Shore D | ISO 868:2003 |
| Tensile properties | Instron 3369 universal | ASTM D638 |
| (tensile strength, | testing machine | |
| tensile modulus, | | |
| elongation at break) | | |
| Impact resistance | Elcometer 1615 impact tester | ASTM D2794 |
| Lap shear strength | Instron 3369 universal | ISO4587-2003 |
| | testing machine | |

### Example 1 (E1)

A 250 ml 4-necked flask equipped with a thermometer, an addition funnel, a Dean-Stark trap, a stirrer and a nitrogen line was charged with JEFFAMINE® D400 (43 g, 0.1 mole) and dimer acid (116 g, 0.2 mole). The mixture was heated to 230° C. for two hours. Amine titration was used to monitor the end of the reaction. When the amine value was lower than 1 mgKOH/g, the reaction mixture was cooled down to 150° C. and N-AEP (27.13 g, 0.21 mole) was added. Then the reaction mixture was maintained at 230° C. for another 2 hours. After cooling to room temperature, an amber liquid was obtained. (amine value: 130 mg KOH/g, viscosity: 65000 cps @40° C.)

### Example 2 (E2)

A 250 ml 4-necked flask equipped with a thermometer, an addition funnel, a Dean-Stark trap, a stirrer and a nitrogen line was charged with Ancamine® 1922A (22 g, 0.1 mole) and dimer acid (116 g, 0.2 mole). The mixture was heated to 230° C. for two hours. Amine titration was used to monitor the end of the reaction. When the amine value was lower than 1 mgKOH/g, the reaction mixture was cooled down to 150° C. and N-AEP (27.13 g, 0.21 mole) was added. Then the reaction mixture was maintained at 230° C. for another 2 hours. After cooling to room temperature, an amber liquid was obtained. (amine value: 151 mg KOH/g, viscosity: 42000 cps @50° C.)

### Example 3 (E3)

A 250 ml 4-necked flask equipped with a thermometer, an addition funnel, a Dean-Stark trap, a stirrer and a nitrogen line was charged with JEFFAMINE® D400 (43 g, 0.1 mole) and dimer acid (116 g, 0.2 mole). The mixture was heated to 230° C. for two hours. Amine titration was used to monitor the end of the reaction. When the amine value was lower than 1 mgKOH/g, the reaction mixture was cooled down to 150° C. and piperazine (18.06 g, 0.21 mole) was added. Then the reaction mixture was maintained at 230° C. for another 4 hours. After cooling to room temperature, an amber liquid was obtained. (amine value: 77 mg KOH/g, viscosity: 26000 cps @40° C.)

### Comparative Example 1 (CE1)

A 250 ml 4-necked flask equipped with a thermometer, an addition funnel, a Dean-Stark trap, a stirrer and a nitrogen line was charged with N-AEP (27.13 g, 0.21 mole), JEFFAMINE® D400 (43 g, 0.1 mole) and dimer acid (116 g, 0.2 mole). The mixture was heated to 230° C. for two hours. Amine titration was used to monitor the end of the reaction. After cooling to room temperature, an amber liquid was obtained. (amine value: ~128 mg KOH/g, viscosity: 50800 cps @40° C.)

### Comparative Example 2 (CE2)

A 250 ml 4-necked flask equipped with a thermometer, an addition funnel, a Dean-Stark trap, a stirrer and a nitrogen line was charged with JEFFAMINE® D400 (43 g, 0.1 mole) and dimer acid (116 g, 0.2 mole). The mixture was heated to 230° C. for two hours. Amine titration was used to monitor the end of the reaction. When the amine value was lower than 1 mgKOH/g, the reaction mixture was cooled down to 150° C. and TETA (30.7 g, 0.21 mole) was added. Then the reaction mixture was maintained at 230° C. for another 2 hours. After cooling to room temperature, an amber liquid was obtained. (amine value: 162 mg KOH/g, viscosity: 68000 cps @40° C.)

### Comparative Example 3 (CE3)

A 250 ml 4-necked flask equipped with a thermometer, an addition funnel, a Dean-Stark trap, a stirrer and a nitrogen line was charged with JEFFAMINE® D400 (43 g, 0.1 mole) and dimer acid (116 g, 0.2 mole). The mixture was heated to 230° C. for two hours. Amine titration was used to monitor the end of the reaction. When the amine value was lower than 1 mgKOH/g, the reaction mixture was cooled down to 150° C. and IPDA (35.76 g, 0.21 mole) was added. Then the reaction mixture was maintained at 230° C. for another 2 hours. After cooling to room temperature, an amber liquid was obtained. (amine value: 65 mg KOH/g, viscosity: 39000 cps @70° C.)

### Comparative Example 4 (CE4)

A 250 ml 4-necked flask equipped with a thermometer, an addition funnel, a Dean-Stark trap, a stirrer and a nitrogen line was charged with JEFFAMINE® D400 (64.5 g, 0.15 mole) and dimer acid (58 g, 0.1 mole). The mixture was heated to 230° C. for two hours. After cooling to room temperature, an amber liquid was obtained. (amine value: 40 mg KOH/g, viscosity: 66000 cps @25° C.)

### Comparative Example 5 (CE5)

JEFFAMINE® D2000 from Huntsman, Polypropylene diamine, MW=2000 g/mol

Table 3 below summarizes the materials and synthesis processes of Examples 1-3 and Comparative Examples 1-5. Except for the amine used in the second step, the preparation of the polyamides in Examples 1 and 3 are the same with that of the polyamides in Comparative Examples 2 and 3.

TABLE 3

| | Composition (mole ratio) | Synthesis process |
|---|---|---|
| E1 | Dimer acid/D400/N-AEP = 2/1/2.1 | One pot, two steps |
| E2 | Dimer acid/1922A/N-AEP = 2/1/2.1 | process |
| E3 | Dimer acid/D400/piperazine = 2/1/2.1 | |
| CE1 | Dimer acid/D400/N-AEP = 2/1/2.1 | one step process |
| CE2 | Dimer acid/D400/TETA = 2/1/2.1 | One pot, two steps |
| CE3 | Dimer acid/D400/IPDA = 2/1/2.1 | process |
| CE4 | Dimer acid/D400 = 1/1.5 | one step process |
| CE5 | D2000 | / |

### Performance Test

To test the performance of the polyamide epoxy curing agents prepared in Examples 1-3 and Comparative Examples 1-5 in adhesive applications, adhesives were prepared according to the formulations in Table 4 (using indicated parts by weight).

Furthermore, the test comprised the following comparative formulations: Formulation 1, which was an adhesive formulation without using any modifiers, and Formulation 5, which was an adhesive formulation using conventional ATBN as a modifier.

The performances of adhesives were determined and the results were summarized in Table 4 below.

Amine hydrogen equivalent weight in g/mol, or AHEW, is calculated as molecular weight of the amine divided by the number of amine hydrogen atoms per molecule.

Epoxide group content, indicated by epoxide equivalent weight or EEW, is the ratio between the molecular weight of the epoxide and the number of epoxide groups.

TABLE 4
Comparison of examples in adhesive application

| | | | | | | | | | | |
|---|---|---|---|---|---|---|---|---|---|---|
| Formulation number | No. 1 | No. 2 | No. 3 | No. 4 | No. 5 | No. 6 | No. 7 | No. 8 | No. 9 | No. 10 |

Part A

| | | | | | | | | | | |
|---|---|---|---|---|---|---|---|---|---|---|
| D.E.R. 331 | 90 | 90 | 90 | 90 | 90 | 90 | 90 | 90 | 90 | 90 |
| Epodil ® 742 | 10 | 10 | 10 | 10 | 10 | 10 | 10 | 10 | 10 | 10 |
| total | 100 | 100 | 100 | 100 | 100 | 100 | 100 | 100 | 100 | 100 |
| Epoxy equivalent | 187 | 187 | 187 | 187 | 187 | 187 | 187 | 187 | 187 | 187 |
| weight (EEW) | | | | | | | | | | |

Part B

| | | | | | | | | | | |
|---|---|---|---|---|---|---|---|---|---|---|
| Ancamide ® 350A | 90 | 60 | 60 | 60 | 60 | 60 | 60 | 60 | 60 | 60 |
| E1 | | 30 | | | | | | | | |
| E2 | | | 30 | | | | | | | |
| E3 | | | | 30 | | | | | | |
| 1300 [symbol] 16 ATBN | | | | | 30 | | | | | |
| CE1 | | | | | | 30 | | | | |
| CE2 | | | | | | | 30 | | | |
| CE3 | | | | | | | | 30 | | |
| CE4 | | | | | | | | | 30 | |
| CE5 | | | | | | | | | | 30 |
| benzyl alcohol | 10 | 10 | 10 | 10 | 10 | 10 | 10 | 10 | 10 | 10 |
| Total | 100 | 100 | 100 | 100 | 100 | 100 | 100 | 100 | 100 | 100 |
| Active hydrogen | 105.6 | 149.2 | 148.0 | 149.2 | 150.4 | 149.2 | 129.3 | 142.3 | 146.6 | 144.6 |
| equivalent | | | | | | | | | | |
| weight (AHEW) | | | | | | | | | | |
| Parts per hundred | 56.4 | 79.8 | 79.2 | 79.8 | 80.4 | 79.8 | 69.1 | 76.1 | 78.4 | 77.3 |
| parts of resin | | | | | | | | | | |
| (PHR) | | | | | | | | | | |
| Dry time(h, II/III | 10.6/ | 11.2/ | 12.4/ | 10.4/ | 10.0/ | 11.4/ | 10.0/ | 10.8/ | / ** | /** |
| phase) 23 °C/24 h | 13.2 | 14.4 | 15.5 | 13.0 | 13.0 | 15.4 | 13.6 | 13.6 | | |
| Tensile strength | 65.9 | 46.4 | 51.0 | 49.6 | 40.1 | 47.1 | 52.6 | 46.1 | 50.1 | 40.1 |
| (MPa)* | | | | | | | | | | |
| Tensile modulus | 2520.5 | 1968.9 | 2067.4 | 2005.2 | 1663.1 | 1995.4 | 2188.6 | 1923.4 | 1928.1 | 1442.3 |
| (MPa)* | | | | | | | | | | |
| Elongation at | 7 | 15 | 10 | 9 | 14 | 10 | 8 | 7 | 4 | 13 |
| break (%)* | | | | | | | | | | |
| hardness | 82 | 80 | 80 | 80 | 78 | 80 | 81 | 79 | 80 | 79 |
| (Shore D)* | | | | | | | | | | |
| lap shear | 16.9 | 22.6 | 20.8 | 30.1 | 24.3 | 18.4 | 21.7 | 19.3 | 18.5 | 18 |
| strength* | | | | | | | | | | |
| CRS-CRS (MPa) | | | | | | | | | | |

*curing condition: 40 °C/16 h + 80 °C/2 h
**phase separation took place during test

To test the performance of the polyamide epoxy curing agents prepared in Examples 1-2 and Comparative Examples 1-5 in coating applications, resin part (Part A) and curing agent part (Part B) of the coatings were prepared according to the formulations in Table 5 (using indicated parts by weight).

Furthermore, the test comprised the following comparative formulations: Formulation 11, which was a coating formulation without using any modifiers, and Formulation 14, which was a coating formulation using conventional ATBN as a modifier.

The performances of coatings were determined and the results were summarized in Table 5 below.

TABLE 5
comparison of examples in coating application

| | | | | | | | | | |
|---|---|---|---|---|---|---|---|---|---|
| Formulation | | | | | | | | | |
| number | No. 11 | No. 12 | No. 13 | No. 14 | No. 15 | No. 16 | No. 17 | No. 18 | No. 19 |

Part A

| | | | | | | | | | |
|---|---|---|---|---|---|---|---|---|---|
| D.E.R. 331 | 100 | 100 | 100 | 100 | 100 | 100 | 100 | 100 | 100 |
| total | 100 | 100 | 100 | 100 | 100 | 100 | 100 | 100 | 100 |
| EEW | 187 | 187 | 187 | 187 | 187 | 187 | 187 | 187 | 187 |

Part B

| | | | | | | | | | |
|---|---|---|---|---|---|---|---|---|---|
| Ancamine ® | 100 | 70 | 70 | 70 | 70 | 70 | 70 | 70 | 70 |
| 1618 | | | | | | | | | |
| E1 | | 30 | | | | | | | |
| E2 | | | 30 | | | | | | |
| 1300 [symbol] 16 | | | | 30 | | | | | |
| ATBN | | | | | | | | | |
| CE1 | | | | | 30 | | | | |
| CE2 | | | | | | 30 | | | |
| CE3 | | | | | | | 30 | | |
| CE4 | | | | | | | | 30 | |
| CE5 | | | | | | | | | 30 |
| Total | 100 | 100 | 100 | 100 | 100 | 100 | 100 | 100 | 100 |
| AHEW | 113.0 | 151.9 | 150.8 | 153.2 | 151.9 | 131.3 | 144.8 | 149.3 | 147.2 |
| PHR | 60.4 | 81.2 | 80.6 | 81.9 | 81.2 | 70.2 | 77.4 | 79.8 | 78.7 |
| Impact 80 μm | 65 | >100 | 80 | >100 | >100 | 35 | <5 | <5 | >100 |
| Kg*cm* | | | | | | | | | |
| Direct | | | | | | | | | |
| Impact 80 μm | 40 | 95 | 65 | 95 | 95 | <5 | <5 | <5 | >100 |
| Kg*cm* | | | | | | | | | |
| Reverse | | | | | | | | | |

*curing condition: 40 °C/16 h + 80 °C/2 h

Good flexibility could be indicated by high elongation in adhesive formulation and high impact resistance in coating formulation. Comparative Example 4, a D400 based polyamide and Comparative Example 5, JEFFAMINE® D2000 are two conventional flexible curing agents. However, CE4 didn't show high elongation and good impact resistance. Although addition of CE5 did improve elongation and impact resistance, but it didn't show enhancement on lap shear strength, which is one of the most important properties for adhesive application. In addition, both CE4 and CE5 showed phase separation during ‘Dry time’ test, which could be explained by poor compatibility and slow curing speed between Jeffamine and epoxy resin.

Comparative Example 1 used the same raw materials as those of Example 1 but was prepared with a different process, which led to a different end functional group and molecular weight. Compared with Comparative Example 1, as shown in Table 4, the formulation with polyamide epoxy curing agent of Example 1 also showed faster curing speed besides better elongation and lap shear strength.

As shown in Table 4, compared with Formulation 1 which did not comprise any modifier, the formulations comprising the polyamide epoxy curing agent of Examples 1-3 exhibited improved performance in both elongation at break and lap shear strength.

As shown in Table 4, compared with Formulation 5, which was an adhesive formulation using conventional ATBN as a modifier, Formulations 2-4 (comprising the polyamide epoxy curing agent of Examples 1-3, respectively) exhibited better performance in tensile strength and tensile modulus. Notably, Formulation 4 which comprises the polyamide epoxy curing agent of Example 3 showed surprisingly superior lap shear strength than that of Formulation 5 and Formulations 6-8 comprising the polyamide epoxy curing agents of Comparative Examples 1-3, respectively.

As shown in Table 4, by comparing Examples 1 and 3 with Comparative Examples 2 and 3, it can be clearly seen that by replacing primary amine terminated polyamide with secondary amine terminated polyamide, the lap shear strength is significantly improved, and the elongation at break is improved as well.

By comparing Examples 1 and 2 with Comparative Examples 2 and 3, as shown in Tables 4 and 5, it is apparent that the block polyamide of the present invention exhibits significant better elongation, lap shear strength and impact resistance than the polyamides of Comparative Examples 2 and 3 and show similar performance in flexibility with ATBN.

As used herein, terms such as “comprise(s)” and the like as used herein are open terms meaning ‘including at least’ unless otherwise specifically noted.

All references, tests, standards, documents, publications, etc. mentioned herein are incorporated herein by reference. Where a numerical limit or range is stated, the endpoints are included. Also, all values and subranges within a numerical limit or range are specifically included as if explicitly written out.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. In this regard, certain embodiments within the invention may not show every benefit of the invention, considered broadly.

1. A secondary amine terminated block polyamide of formula (I): 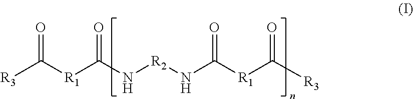
wherein each R₁ independently represents a divalent aliphatic or aromatic group having an average molecular weight of 42 to about 700 and containing from 3 to 42 carbon atoms;
wherein R₂ represents: 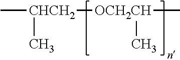
wherein n′ represents a positive number having an average value of 2 to 80, or 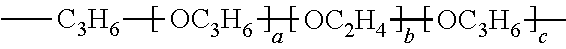
wherein —C3H₆— may be linear or branched, a+c equals a positive number having an average value of 2 to about 10 and b is a positive number having an average value of from 1 to about 50, or 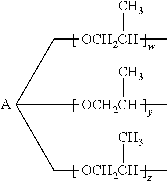
wherein A represents a trivalent hydrocarbon group consisting of 3 to 6 carbon atoms, resulting from the propoxylation of a propoxylation susceptible trihydric alcohol containing from 3 to 6 carbon atoms, and
w, y and z are positive integers and the average value of the sum of w+y+z is from 4 to about 120;
n represents an integer from 1 to 10;
wherein each R₃ independently represents a monovalent group having the formula:
R₄NH—R₅—NR₆—,
wherein R₄ and R₅ each independently represents an aliphatic, alicyclic, or aromatic group containing 1 to 10 carbon atoms,
wherein R₆ represents a hydrogen atom or an aliphatic, alicyclic, or aromatic group containing 1 to 10 carbon atoms; or
each R₃ independently represents a monovalent group having the formula: 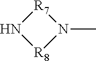
wherein R₇ and R₈ form, together with the two nitrogen atoms to which R₇ and R₈ are attached, an optionally alkyl groups substituted 4 to 7-membered heterocycle; or
each R₃ independently represents a monovalent group having the formula: 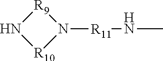
wherein R₉ and R₁₀ form, together with the two nitrogen atoms to which R₉ and R₁₀ are attached, an optionally alkyl groups substituted 4 to 7-membered heterocycle,
wherein R₁₁ represents a divalent aliphatic saturated or unsaturated hydrocarbon group containing from 1 to 10 carbon atoms;
wherein said block polyamide has an average molecular weight ranging from about 800 to about 8000.

2. The polyamide of claim 1, wherein R₁ is selected from divalent propyl, divalent butyl, divalent heptyl, divalent octyl, divalent decyl, or derived from dimer acids from dimerization of tall oil fatty acids.

3. The polyamide of claim 1, wherein R₂ represents: 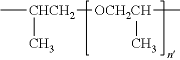
where n′=2.6, 5.6 or 33 or R₂ represents 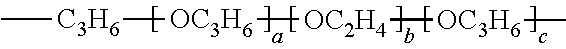
where b is about 8.5 and the value of a+c is about 2.5, or the value of a+c is about 2.5 and the value of b is about 15.5, or a+c has a value of about 2.5 and the value of b is about 40, or a=0, c=1, b=2, or R₂ represents 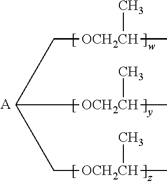
where A represents a trimethylol propane nucleus, and containing an average of about 5.3 oxypropylene groups, or A represents a trimethylol propane nucleus, and containing about 50 oxypropylene groups, or A represents a glycerol nucleus and containing about 86 oxypropylene groups.

4. The polyamide of claim 1, wherein R₆ represents a hydrogen atom.

5. The polyamide of claim 1, wherein R₇ and R₈ form, together with the two nitrogen atoms to which R₇ and R₈ are attached, a piperazinium ring, the piperazinium ring being optionally alkyl groups substituted.

6. The polyamide of claim 1, wherein R₉ and R₁₀ form, together with the two nitrogen atoms to which R₉ and R₁₀ are attached, a piperazinium ring, the piperazinium ring being optionally alkyl groups substituted.

7. The polyamide of claim 1, wherein R₃ is derived from diamines selected from the group consisting of N-(2-aminoethyl)piperazine, piperazine, and 3-(cyclohexylamino)-1-propylamine.

8. A process for preparing the secondary amine terminated block polyamide of claim 1, comprising
(1) reacting a polyoxyalkylene polyamine NH₂R₂NH₂ or R₂ (NH₂)₃ with a dicarboxylic acid having the formula COOH—R₁—COOH) or an anhydride or a C1-C4 alkyl ester thereof to provide a carboxyl terminated prepolymer; and
(2) reacting the carboxyl terminated prepolymer with a diamine R₃H to give the secondary amine terminated block polyamide;
wherein R₁, R₂, R₃ are as defined in claim 1.

9. The process of claim 8, wherein R₁ each independently represents a divalent aliphatic saturated or unsaturated hydrocarbon group containing from 3 to 42 carbon atoms.

10. The process of claim 9, wherein said dicarboxylic acid is selected from adipic acid, azelaic acid, glutaric acid, sebacic acid, dimer acids from dimerization of tall oil fatty acids.

11. The process of claim 8, wherein R₂ represents: 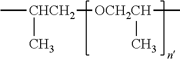
where n′=2.6, 5.6 or 33 or R₂ represents 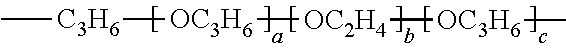
where b is about 8.5 and the value of a+c is about 2.5, or the value of a+c is about 2.5 and the value of b is about 15.5, or a+c has a value of about 2.5 and the value of b is about 40, or a=0, c=1, b=2, or R₂ represents 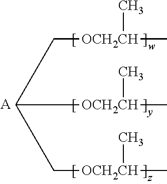
Where A represents a trimethylol propane nucleus, and containing an average of about 5.3 oxypropylene groups, or A represents a trimethylol propane nucleus, and containing about 50 oxypropylene groups, or A represents a glycerol nucleus and containing about 86 oxypropylene groups.

12. The process of claim 8, wherein each R₃ independently represents a monovalent group having the formula: R₄NH—R₅—NR₆—, wherein R₄ and R₅ each independently represents an aliphatic, alicyclic, or aromatic group containing 1 to 10 carbon atoms, and wherein R₆ represents a hydrogen atom.

13. The process of claim 8, wherein each R₃ independently represents a monovalent group having the formula: 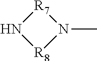
wherein R₇ and R₈ form, together with the two nitrogen atoms to which R₇ and R₈ are attached, a piperazinium ring, the piperazinium ring being optionally substituted.

14. The process of claim 8, wherein each R₃ independently represents a monovalent group having the formula: 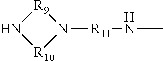
wherein R₉ and R₁₀ form, together with the two nitrogen atoms to which R₉ and R₁₀ are attached, a piperazinium ring, the piperazinium ring being optionally substituted.

15. The process of claim 8, wherein R₃H represents diamines selected from the group consisting of N-(2-Aminoethyl)piperazine, piperazine, and 3-(cyclohexylamino)-1-propylamine.

16. An epoxy curing composition, at least comprising the secondary amine terminated block polyamide of claim 1.

17. An epoxy formulation, selected from coatings, adhesive, mortars, fiber reinforced composites, which comprises the epoxy curing composition of claim 16 and an epoxy resin.

18. A cured product of the epoxy formulation of claim 17.

19. An article comprising the cured product of claim 18 and a substrate such as metal, plastic, ceramic, concrete.

20. A method of preparing in coatings, adhesives, fiber reinforced composites, and mortars comprising reacting the secondary amine terminated block polyamide of claim 1 with at least one epoxy resin.
